(19) United States
(12) Patent Application Publication
(10) Pub. No.: US 2026/0073256 A1
(43) Pub. Date: Mar. 12, 2026

(54) ENHANCING REASONING CAPABILITIES IN A VISION LANGUAGE MODEL (VLM) WITH GENERATIVE FLOW NETWORKS (GFLOWNETS)

(71) Applicant: HONDA MOTOR CO., LTD., Tokyo (JP)

(72) Inventors: Haoqiang KANG, Bellevue, WA (US); Enna SACHDEVA, Santa Clara, CA (US); Piyush GUPTA, San Jose, CA (US); Sangjae BAE, Mountain View, CA (US); Kwonjoon LEE, Sunnyvale, CA (US)

(21) Appl. No.: 19/322,644

(22) Filed: Sep. 8, 2025

Related U.S. Application Data
(60) Provisional application No. 63/692,596, filed on Sep. 9, 2024.

(51) Int. Cl. G06N 5/04; G06F 40/284

(52) U.S. Cl. CPC G06N 5/04; G06F 40/284

(57) ABSTRACT

According to one aspect, enhancing reasoning capabilities in a vision language model (VLM) with generative flow networks (GFlowNets) may include generating a chain of thought (CoT) reasoning and an action for a first time-step based on a vision language model (VLM), an input observation image, and an input text prompt, generating an action space for a second time-step and a sequence of transitions based on a simulation environment, the CoT, and the action for the first time-step, and fine-tuning the VLM based on updating a forward policy of a generative flow network (Gflownet) based on buffering the sequence of transitions and one or more losses.

### CROSS REFERENCE TO RELATED APPLICATIONS

This application claims the benefit of U.S. Provisional Patent Application, Ser. No. 63/692,596 (Attorney Docket No. H1242187US01) entitled “ENHANSING REASONING CAPABILITIES IN VISION-LANGUAGE MODELS VIA SYSTEM 2 INDUCTIVE BIAS WITH GFLOWNET”, filed on Sep. 9, 2024; the entirety of the above-noted application(s) is incorporated by reference herein.

### BACKGROUND

Vision-Language Models (VLMs) have achieved remarkable results in generalized tasks such as image captioning and visual question answering. However, VLMs struggle with structured reasoning in sequential decision-making tasks that require causal understanding data, especially in long horizon planning for tasks such as embodied artificial intelligence (AI), where an agent must capture long term dependencies. While VLMs have demonstrated remarkable performance in certain benchmarks, they still lack capabilities in 3D spatial reasoning, such as recognizing quantitative relationships of physical objects like distances or size differences.

### BRIEF DESCRIPTION

According to one aspect, a system for enhancing reasoning capabilities in a vision language model (VLM) with generative flow networks (GFlowNets) may include a processor and a memory. The memory may store one or more instructions. The processor may execute one or more of the instructions stored on the memory to perform one or more acts, actions, and/or steps. The processor may generate a chain of thought (CoT) reasoning and an action for a first time-step based on a vision language model (VLM), an input observation image, and an input text prompt. The processor may generate an action space for a second time-step and a sequence of transitions based on a simulation environment, the CoT, and the action for the first time-step. The processor may fine-tune the VLM based on updating a forward policy of a generative flow network (Gflownet) based on buffering the sequence of transitions and one or more losses.

The system for enhancing reasoning capabilities in the VLM with GFlowNets may include a sensor sensing the input observation image. The input text prompt may include a goal description, a history of states, a history of actions, and the action space. The VLM may include an encoder and a projector generating a vision encoding for the VLM based on the input observation image. The VLM may include a text tokenizer generating a text token for the VLM based on the input text prompt. The simulation environment may execute the action to generate a reward, an observation at the second time-step, and the action space for the second time-step. The processor may generate a text prompt for the second time-step based on a function, a history of states, a history of actions, the action space for a second time-step, and an observation at the second time-step.

One or more of the losses may be a Variance Trajectory-Balanced (TB) loss that ensures a probability of generating a complete trajectory is proportional to a reward. One or more of the losses may be a Subtrajectory-Balanced (SubTB) loss that ensures a segment of a CoT reasoning path remains consistent. One or more of the losses may be a Detailed Balanced (DB) loss that ensures that a transition between a first state and a second state is balanced by matching a forward flow and a backward flow at each step of a trajectory.

According to one aspect, a computer-implemented method for enhancing reasoning capabilities in a vision language model (VLM) with generative flow networks (GFlowNets) may include generating a chain of thought (CoT) reasoning and an action for a first time-step based on a vision language model (VLM), an input observation image, and an input text prompt, generating an action space for a second time-step and a sequence of transitions based on a simulation environment, the CoT, and the action for the first time-step, and fine-tuning the VLM based on updating a forward policy of a generative flow network (Gflownet) based on buffering the sequence of transitions and one or more losses.

The input text prompt may include a goal description, a history of states, a history of actions, and the action space. One or more of the losses may be a Variance Trajectory-Balanced (TB) loss that ensures a probability of generating a complete trajectory is proportional to a reward. One or more of the losses may be a Subtrajectory-Balanced (SubTB) loss that ensures a segment of a CoT reasoning path remains consistent. One or more of the losses may be a Detailed Balanced (DB) loss that ensures that a transition between a first state and a second state is balanced by matching a forward flow and a backward flow at each step of a trajectory.

According to one aspect, a system for enhancing reasoning capabilities in a vision language model (VLM) with generative flow networks (GFlowNets) may include a processor and a memory. The memory may store one or more instructions. The processor may execute one or more of the instructions stored on the memory to perform one or more acts, actions, and/or steps. The processor may generate a chain of thought (CoT) reasoning and an action for a first time-step based on a vision language model (VLM), an input observation image, and an input text prompt. The processor may generate an action space for a second time-step and a sequence of transitions based on a simulation environment, the CoT, and the action for the first time-step. The VLM is fine-tuned during a training stage based on updating a forward policy of a generative flow network (Gflownet) based on buffering a sequence of transitions from the training stage and one or more losses.

The input text prompt may include a goal description, a history of states, a history of actions, and the action space. One or more of the losses may be a Variance Trajectory-Balanced (TB) loss that ensures a probability of generating a complete trajectory is proportional to a reward. One or more of the losses may be a Subtrajectory-Balanced (SubTB) loss that ensures a segment of a CoT reasoning path remains consistent. One or more of the losses may be a Detailed Balanced (DB) loss that ensures that a transition between a first state and a second state is balanced by matching a forward flow and a backward flow at each step of a trajectory.

### BRIEF DESCRIPTION OF THE DRAWINGS

FIG. 1 is an exemplary component diagram of a system for enhancing reasoning capabilities in a vision language model (VLM) with generative flow networks (GFlowNets), according to one aspect.

FIG. 2 is an exemplary flow diagram of a computer-implemented method for enhancing reasoning capabilities in a vision language model (VLM) with generative flow networks (GFlowNets), according to one aspect.

FIG. 3 is an exemplary scenario associated with the system for enhancing reasoning capabilities in a vision language model (VLM) with generative flow networks (GFlowNets) of FIG. 1, according to one aspect.

FIG. 4 is an exemplary input associated with the system for enhancing reasoning capabilities in a vision language model (VLM) with generative flow networks (GFlowNets) of FIG. 1, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

According to one aspect, enhancing reasoning capabilities in a vision language model (VLM) with generative flow networks (GFlowNets) may be achieved by utilizing GFlowNet's structure learning to enhance the VLM's ability to obtain high-quality, diverse solutions whose distribution is proportional to the reward function. By fine tuning VLMs using GFlowNets, the benefit and advantage of allowing solutions to be sampled from the distribution of the reward function may include mitigating learning policies settled around a small number of modes.

The system for enhancing reasoning capabilities in a VLM with GFlowNets may take a current observation image oₜ and a designed task specific prompt pₜ as the input. According to one aspect, pₜ may include a description of the goal, historical actions a_{1:t-1}, history states s_{1:t-1}, and admissible action space corresponding to the current observation oₜ. To incorporate non-Markovian assumptions, input z_{0:t} may include historical actions a_{0:t} and states s_{0:t}, respectively along with the input image oₜ. The output may include Chain-of-Thought (CoT) reasoning cₜ and action aₜ, where aₜ directly interacts with the environment.

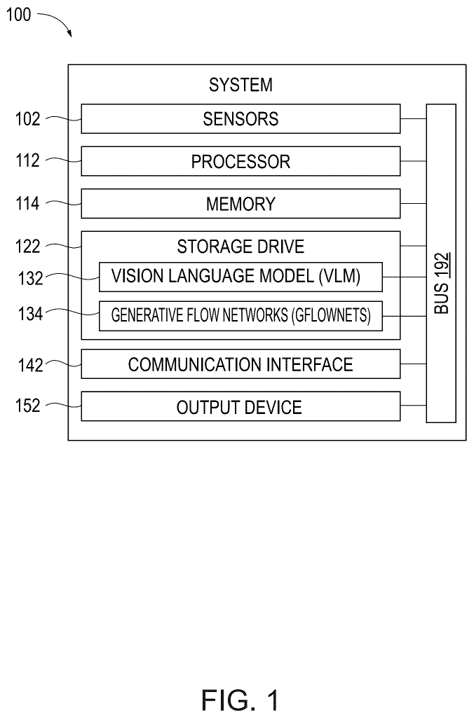

FIG. 1 is an exemplary component diagram of a system 100 for enhancing reasoning capabilities in a vision language model (VLM) with generative flow networks (GFlowNets), according to one aspect. The system 100 for enhancing reasoning capabilities in the VLM with GFlowNets may include one or more sensor 102, a processor 112, a memory 114, and a storage drive 122. The storage drive 122 may store a vision language model (VLM) 132, one or more GFlowNets 134, a database, etc. The system 100 for enhancing reasoning capabilities in the VLM with GFlowNets may include a communication interface 142, an output device 152, and a bus 192.

The sensor 102 may include an image capture device sensing an input observation image. The memory 114 may store one or more instructions. The processor 112 may execute one or more of the instructions stored on the memory 114 to perform one or more acts, actions, and/or steps and may be implemented as part of a controller. The communication interface 142 may receive one or more models to be stored on the storage drive 122, such as the VLM 132 or the GFlowNets 134 from an external server and transmit the respective models to the storage drive 122 for storage. The bus 192 may operably connect one or more of the components of the system 100 for enhancing reasoning capabilities in the VLM with GFlowNets, such as the sensor 102, the processor 112, the memory 114, the storage drive 122, the communication interface 142, and the output device 152. In this way, computer communication between the respective components may be enabled.

The processor 112 may generate a chain of thought (CoT) reasoning and an action for a first time-step based on the VLM 132, an input observation image, and an input text prompt. Here, the VLM 132 may receive the input observation image and the input text prompt to generate the CoT reasoning and the action. The input text prompt may include a goal description, a history of states, a history of actions, and the action space. The VLM 132 may include an encoder and a projector generating a vision encoding for the VLM 132 based on the input observation image. The VLM 132 may include a text tokenizer generating a text token for the VLM 132 based on the input text prompt.

The processor 112 may generate an action space for a second time-step and a sequence of transitions based on a simulation environment, the CoT, and the action for the first time-step. In other words, the simulation environment may execute the action to generate a reward, an observation at the second time-step, and the action space for the second time-step. The processor 112 may generate a text prompt for the second time-step based on a function, a history of states, a history of actions, the action space for a second time-step, and an observation at the second time-step.

The processor 112 may fine-tune the VLM 132 based on updating a forward policy of a generative flow network (Gflownet) based on buffering the sequence of transitions and one or more losses. One or more of the losses may be a Variance Trajectory-Balanced (TB) loss that ensures a probability of generating a complete trajectory is proportional to a reward. One or more of the losses may be a Subtrajectory-Balanced (SubTB) loss that ensures a segment of a CoT reasoning path remains consistent. One or more of the losses may be a Detailed Balanced (DB) loss that ensures that a transition between a first state and a second state is balanced by matching a forward flow and a backward flow at each step of a trajectory.

According to one aspect, the output device 152 may include a display device and/or a speaker. Additionally, the output device 152 may be implemented as a mobile device, according to one aspect. The output device 152 may render or output one or more results generated by the system 100 for enhancing reasoning capabilities in the VLM with GFlowNets, the VLM 132, the GFlowNets 134, etc. The output device 152 may be implemented on a robot or implemented on one or more robot systems.

### Generative Flow Networks

Generally, GFlowNets 134 are models that amortize the cost of sampling from a target distribution over terminal states χ by learning an approximation of this distribution based on its reward function. Given a directed acyclic graph (DAG) G=(S, [symbol] ) with states S and directed actions [symbol] , there is an initial state s₀ and terminal states X⊂S. A trajectory τ=(s₀→ . . . →sₙ) represents a complete sequence ending in a terminal state x∈X. The trajectory flow F:T→ [symbol] ⁺ defines flows over trajectories, with state flow F(s)=Σ_{s∈τ}F(τ). A forward policy P_{F}(⋅|s), often parametrized by a neural network, may induce a distribution over trajectories and a marginal distribution over terminal states with probabilities given by:

$${P}_{F} ( τ ) = {P}_{F} ( {s}_{0} \to … \to {s}_{n} ) = {\prod }_{t = 0}^{n - 1} {P}_{F} ( {s}_{t + 1} \vert {s}_{t} ) ∀ τ ∈ 𝒯 .$$

Similarly, a backward policy

$${P}_{B} ( τ ) = {P}_{B} ( {s}_{n} \to … \to {s}_{0} ) = {\prod }_{t = 0}^{n - 1} {P}_{B} ( {s}_{t} \vert {s}_{t + 1} ) ∀ τ ∈ 𝒯 .$$

Given a non-negative reward function R:X→ [symbol] ⁺, GFlowNets 134 may estimate a policy where the likelihood of sampling x∈X is proportional to R(x). Thus, there exists a constant Z such that:

R(x)=Z Σ_{τ=(s}_{₀}_{→ . . . →s}_{ₙ}₌ₓ₎ P_{F}(τ) ∀x∈X, where Z=F (s₀)= [symbol] F(τ) is a total flow at the initial state.

### Fine Tuning Vlms Using Gflownets to Estimate Actions

The system 100 for enhancing reasoning capabilities in a VLM with GFlowNets may use a non-Markovian approach, useful for reasoning tasks that depend on multiple past states to capture long-term dependencies, and tackle longer sequences; challenges that the Markovian assumption cannot adequately address. The processor 112 may fine tune the VLM 132 of LLaVA as a policy for structured reasoning, where the VLM 132 serves as the forward policy P_{F}, selecting the next action aₜ that advances the reasoning chain at every step t. For each task [symbol] , the processor 112 takes the visual observation oₜ and prompt pₜ as inputs, and outputs the CoT and action.

### Prompt Design

To incorporate historical context in decision-making, the processor 112 may modify a prompt template to include a history of states and actions predicted by the VLM 132. The textual prompt pₜ may include the goal description g, the history of states s_{0:t} and actions a_{0:t}, and the action spaced [symbol] ₜ₊₁ available after interacting with the environment. For certain tasks q that may include observation-dependent information, such as the textual description d(oₜ₊₁) of the observation oₜ₊₁, the function ƒ may generate the prompt pₜ₊₁ as: pₜ₊₁=f(d(oₜ₊₁) [symbol] , where [symbol] may be an indicator function which may be 1 only for a certain task q if the observation-dependent information is available.

### Action Selection

Before selecting an action at each step t, the processor 112 may incorporate a CoT reasoning mechanism, by generating one or more intermediate reasoning steps to guide the action selection process. At time t, the VLM 132 may generate a reasoning CoT cₜ, which may include a description of the image and intermediate thoughts. Since VLMs may be pre-trained on large-scale image-caption data, CoT steps may provide additional context and help the processor 112 explicitly consider dependencies between different states before selecting the next action. The CoT may guide the action selection. The probabilities for the CoT and action sequences of tokens may be defined as follows:

$${P}_{CoT} ( {c}_{t} \vert {z}_{0 : t} , g ; θ ) = \qquad ( 1 )$$

$${\sum }_{j = 1}^{{n}_{c}} log {P}_{VLM} ( {w}_{j} \vert {w}_{< j} , {z}_{0 : t} , g ; θ ) \qquad ( 2 )$$

$${P}_{Action} ( {a}_{t} \vert {c}_{t} , {z}_{0 : t} , g ; θ ) = \qquad ( 3 )$$

$${\sum }_{i = 1}^{{n}_{a}} {P}_{VLM} ( {w}_{i} \vert {w}_{< i} , {c}_{t} , {z}_{0 : t} , g ; θ ) \qquad ( 4 )$$

where n_{c} and nₐ represent the number of tokens in the CoT sequence cₜ and action sequence aₜ, respectively, and wᵢ represents the i-th text token in a sequence. Here, P_{VLM}(wᵢ|w_{<i}, z_{0:t}, cₜ, g; θ) and P_{VLM}(wⱼ|w_{<j}, z_{0:t}, g; θ) may denote the VLM's token-level probabilities for the action and CoT sequences, conditioned on previous tokens, the history of states z_{0:t}, the history of actions a_{0:t-1}, and the goal description g. The log forward policy P_{F}(zₜ₊₁|z_{0:t}, g, θ) may be computed by the processor 112 as a weighted sum of the log probabilities of CoT tokens P_{CoT}(cₜ|z_{0:t}, g, θ), based on the CoT reasoning, and the original log action probabilities P_{Action}(aₜ|z_{0:t}, g, θ):

$$log {P}_{F} ( {z}_{t + 1} \vert {z}_{0 : t} , g ; θ ) = log {P}_{Action} ( {a}_{t} \vert {z}_{0 : t} , {c}_{t} , g ; θ ) + λ log {P}_{CoT} ( {c}_{t} \vert {z}_{0 : t} , g ; θ ) \qquad ( 5 )$$

where λ∈[0, 1] is a weighting factor that controls the influence of the CoT reasoning on the final action selection. The CoT probabilities P_{CoT}(cₜ|z_{0:t}, g, θ) may provide a structured, intermediate reasoning context that refines the decision-making process, ensuring that the final action may be selected with consideration of both direct state information and the processor's internal thought process.

### Training Objectives

Three different objective functions of GFlowNets 134 may be adopted, Trajectory-Balance (TB), Subtrajectory-Balance (SubTB), and Detailed-Balance (DB), to fine tune the VLM 132. zₜ may be defined as the state in the trajectory sequence that includes both aₜ, sₜ, and oₜ.

### Variance Trajectory Balanced (Var-Tb) Loss

The Trajectory-Balanced (TB) objective ensures that the probability of generating a complete trajectory τ=(z₀→z₁→ . . . →zₙ=x) is proportional to the reward R(x). This objective may be given by:

$${ℒ}_{VarTB} ( τ ; θ ) = \frac{1}{N} {\sum }_{i = 1}^{N} {( ζ ( {τ}_{i} ; θ ) - {𝔼}_{τ} [ ζ ( τ ; θ ) ] )}^{2} \qquad ( 6 )$$

where N represents the number of sampled trajectories. The TB loss ensures that the high-reward trajectories may be sampled more frequently by the policy. Under the Markovian assumption, the forward policy P_{F}(sₜ|sₜ₋₁) transitions from state sₜ₋₁ to sₜ, while the backward policy P_{B}(sₜ₋₁|sₜ) ensures consistency between forward and backward flows. This objective may be given by:

$$Z {\prod }_{t = 1}^{n} {P}_{F} ( {s}_{t} \vert {s}_{t - 1} ; θ ) = R ( x ) {\prod }_{t = 1}^{n} {P}_{B} ( {s}_{t - 1} \vert {s}_{t} ; θ ) \qquad ( 7 )$$

where Z is the partition function that normalizes the distribution.

s may be changed to z to match definitions, where z_{0:t} may include a visual observation oₜ and an input prompt pₜ including goal description, history states s_{0:t-1}, history actions a_{0:t-1}, and admissible actions [symbol] ₜ. T which may be the [DONE] symbol, to represent the terminal state x of a trajectory. This notation may be adopted because the VLM 132 may predict the action T to signify termination. This practical adaptation ensures consistency between the theoretical representation of terminal states and the actual predictions made by the VLM 132 during inference.

Under the non-Markovian assumption of generating a complete trajectory τ=(z₀→z₁→ . . . →zₙ=x), and after adding a goal into the conditions:

$$Z {\prod }_{t = 1}^{n} {P}_{F} ( {z}_{t} \vert {z}_{0 : t - 1} , g ; θ ) = R ( x ) {\prod }_{t = 1}^{n} {P}_{B} ( {z}_{t - 1} \vert {z}_{t : n} , g ; θ ) \qquad ( 8 )$$

An estimation Z for each trajectory τ may be expressed as:

$$ζ ( τ ; θ , g ) = log \frac{{\prod }_{t = 1}^{n} {P}_{F} ( {z}_{t} \vert {z}_{0 : t - 1} , g ; θ )}{R ( x ) {\prod }_{t = 1}^{n} {P}_{B} ( {z}_{t - 1} \vert {z}_{t : n} , g ; θ )} = log \frac{{\prod }_{t = 1}^{n} {P}_{F} ( {z}_{t} \vert {z}_{0 : t - 1} , g ; θ )}{R ( x )} \qquad ( 9 )$$

where P_{B}=1 in the case since the trajectories may be formulated as a tree structure, where a child state has only one parent state. In the optimal case, ξ(τ; θ, g) may be equal to true log Z. The VAR-TB loss function may aim to minimize the variance of ξ(τ; θ, g) across trajectories to make the balance of the trajectories. Thus, the VAR-TB loss may be defined as:

$${ℒ}_{VarTB} ( τ ; θ ) = \frac{1}{N} {\sum }_{i = 1}^{N} {( ζ ( {τ}_{i} ; θ , g ) - {𝔼}_{τ} [ ζ ( τ ; θ , g ) ] )}^{2} \qquad ( 10 )$$

where N represents the number of sampled trajectories. The VAR-TB loss ensures that high-reward trajectories may be sampled more frequently by the policy. In this way flow estimation F may be replaced with a variance variant (for TB).

### Subtrajectory Balanced (Subtb) Loss

The Subtrajectory-Balanced (SubTB) loss may operate on sub-trajectories of the form z_{0:m}=(z₀→z₁→ . . . →zₘ). SubTB may ensure that each segment of the reasoning path or structure remains consistent, where the flows is balanced locally between forward and backward transitions. SubTB loss may be modified as follows:

$${ℒ}_{SubTB} ( {z}_{0 : m} , g , θ ) = \qquad ( 11 )$$

$${\sum }_{0 \leq i \leq j \leq m} {( log \frac{R ( {z}_{0 : i} ⊤ ) {\prod }_{k = i + 1}^{j} {P}_{F} ( {z}_{k} \vert {z}_{0 : k - 1} , g , θ ) {P}_{F} ( ⊤ \vert {z}_{0 : j} , g , θ )}{R ( {z}_{0 : i} ⊤ ) {P}_{F} ( ⊤ \vert {z}_{0 : i} , g , θ )} )}^{2}$$

where τ is the [DONE] symbol, denoting the terminal state, and the process continues until the [DONE] symbol τ is generated. The SubTB loss may penalize discrepancies in local transitions and ensure that subsegments of a trajectory follow the correct balance conditions, reducing variance in smaller parts of the trajectory.

The SubTB may ensure that each segment of the reasoning path or structure remains consistent, where the flows is balanced locally between forward and backward transitions. Under the non-Markovian assumption and after adding a goal into the conditions, the SubTB balance condition may be expressed as:

$$F ( {z}_{0} ) {\prod }_{t = 1}^{m} {P}_{F} ( {z}_{t} \vert {z}_{0 : t - 1} ) , g ; θ ) = F ( {z}_{m} ) {\prod }_{t = 1}^{m} {P}_{B} ( {z}_{t - 1} \vert {z}_{t : m} ) , g ; θ ) \qquad ( 12 )$$

where F(z₀) and F(zₘ) represent the flow into the initial (z₀) and the final state (zₘ) of the subtrajectory, respectively. Following, when states zₜ may be terminable with τ, F(zₜ)P_{F}(τ|z_{0:t})=R(τ).

### Detailed Balanced (DB) Loss

The Detailed-Balanced (DB) loss may be used to ensure that each transition zₜ→zₜ₊₁ between two states is balanced by matching the forward and backward flows at every step of the trajectory. Since DB loss takes transition as an input, dense rewards may be desired.

The DB loss ensures that every state-to-state transition follows the correct flow, preventing inconsistencies in the trajectory construction. The detailed balance condition may be expressed as:

$$F ( {s}_{t} ) {P}_{F} ( {s}_{t + 1} \vert {s}_{t} ) = F ( {s}_{t + 1} ) {P}_{B} ( {s}_{t} \vert {s}_{t + 1} ) \qquad ( 13 )$$

where F(sₜ) and F(sₜ₊ᵢ) represent the flow at states sₜ and sₜ₊₁, respectively. Under the non-Markovian assumption of generating a complete trajectory τ=(z₀→z₁→ . . . →zₙ→τ), where τ is the terminal state of the sequence, DB loss may be formulated as:

$${ℒ}_{DB} ( {z}_{0 : t} \to {z}_{0 : t + 1} , g , θ ) = {( log \frac{R ( {z}_{0 : t} ⊤ ) {P}_{F} ( {z}_{t + 1} \vert {z}_{0 : t} , g ; θ ) {P}_{F} ( ⊤ \vert {z}_{0 : t + 1} , g ; θ )}{R ( {z}_{0 : t + 1} ⊤ ) {P}_{F} ( ⊤ \vert {z}_{0 : t} , g ; θ )} )}^{2} \qquad ( 14 )$$

The DB loss ensures that every state-to-state transition follows the correct flow, thus mitigating inconsistencies in the trajectory construction.

One challenge when implementing both the SubTB and DB losses is accurately estimating the termination probability, P_{F}(τ|z_{0:t}, g; θ), which represents the likelihood of reaching a terminal state at any point in the trajectory. Incorrect estimation of this probability may lead to suboptimal training and unbalanced flows. To address this, a new token, [DONE] may be introduced into the tokenizer to explicitly model the terminal state, and to use distinct prompt designs. Moreover, the processor 112 may perform an additional Supervised Fine-Tuning (SFT) step on correctly labeled examples before applying GFlowNets training. In other words, SubTB and DB losses may be initialized with an SFT model for the advantage of better performance. This initialization helps the processor 112 better estimate termination probabilities, resulting in improved overall performance.

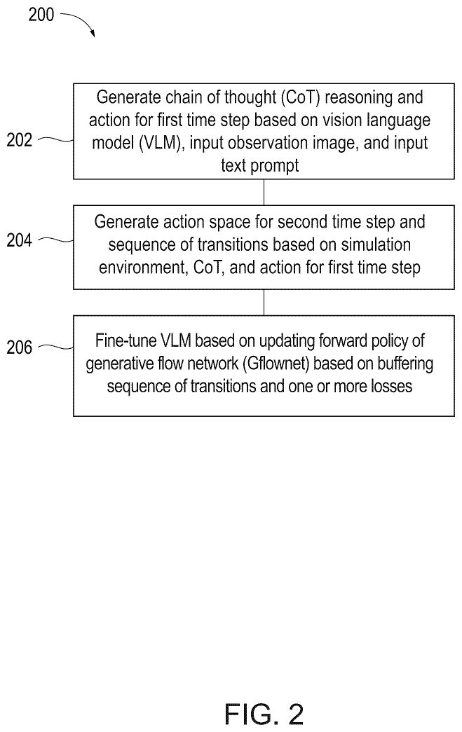

FIG. 2 is an exemplary flow diagram of a computer-implemented method for enhancing reasoning capabilities in a VLM with GFlowNets, according to one aspect. The computer-implemented method for enhancing reasoning capabilities in a vision language model (VLM) with generative flow networks (GFlowNets) may include generating 202 a chain of thought (CoT) reasoning and an action for a first time-step based on a vision language model (VLM), an input observation image, and an input text prompt, generating 204 an action space for a second time-step and a sequence of transitions based on a simulation environment, the CoT, and the action for the first time-step, and fine-tuning 206 the VLM based on updating a forward policy of a generative flow network (Gflownet) based on buffering the sequence of transitions and one or more losses.

According to one aspect, the computer-implemented method for enhancing reasoning capabilities in a VLM with GFlowNets may include implementing the below Algorithm:

Algorithm Training VLM with GFlowNets

```
Input: An environment env, an initial VLM with parameters
θ₀, a CoT reasoning scaling factor λ, maximum episode
length
T, number of tasks W, number of collected trajectories per task
K.
for w = 1, ... , W do [symbol]
  _{w} = Ø
  for k = 1, ... , K do
    t = 0
    g, oₜ, [symbol]   ₜ = env.reset( )
    pₜ = f(oₜ, [symbol]   ₜ)
    while t ≤ T do
      z_{0:t} = [symbol]   oₜ, pₜ [symbol]
      cₜ, aₜ = arg max P_{F}(zₜ₊₁|z_{0:t}, g; θ_{w-1})
      rₜ, oₜ₊₁, [symbol]   ₜ₊₁ = env.step(aₜ) [symbol]
      _{w} = [symbol]   _{w} ∪ {(sₜ, cₜ, aₜ, rₜ}
      pₜ₊₁ = f(d(oₜ₊₁) · [symbol]   _{{q}},
          s_{0:t}, a_{0:t}, [symbol]   ₜ₊₁)
      t = t + 1
      if t = T or task w may be completed then
        break
      end if
    end while
  end for
  Update θ_{w-1} on the collected trajectories [symbol]   _{w} for task w to
obtain θ_{w}
end for
Output: Updated parameters θ_{w} after W tasks.
```

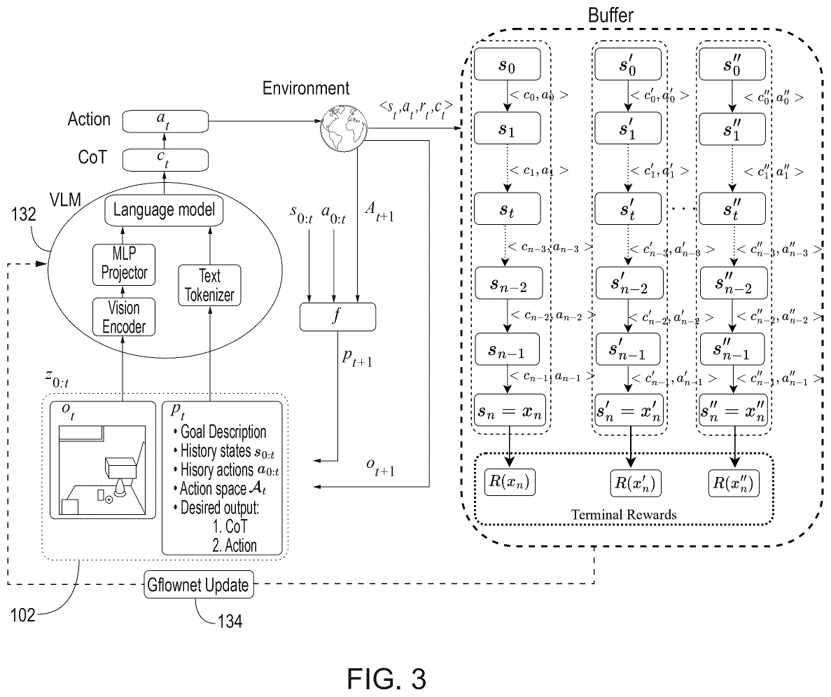

FIG. 3 is an exemplary scenario associated with the system for enhancing reasoning capabilities in a VLM with GFlowNets of FIG. 1, according to one aspect. FIG. 3 demonstrates an overall framework for fine-tuning large VLMs using GFlowNets. The input z_{0:t} at time-step t may include a visual observation oₜ and an input prompt pₜ including a goal description, one or more history states s_{0:t-1}, one or more history actions a_{0:t-1}, and one or more admissible actions [symbol] ₜ, and may output CoT reasoning cₜ, and action aₜ. The aₜ may be executed in the environment to obtain a reward rₜ(sₜ, aₜ), a next observation oₜ₊₁, and an action space [symbol] ₜ₊₁, if may be utilized to generate the next prompt pₜ₊₁ using a description of a next observation oₜ₊₁, if applicable, a history of states s_{0:t}, one or more actions a_{0:t}, and one or more next admissible actions [symbol] ₜ₊₁. The sequence of transitions <sₜ, aₜ, rₜ, cₜ> may be added to the buffer to update the forward policy P_{F} using GFlowNets. xₙ may represent the terminal state of a sequence.

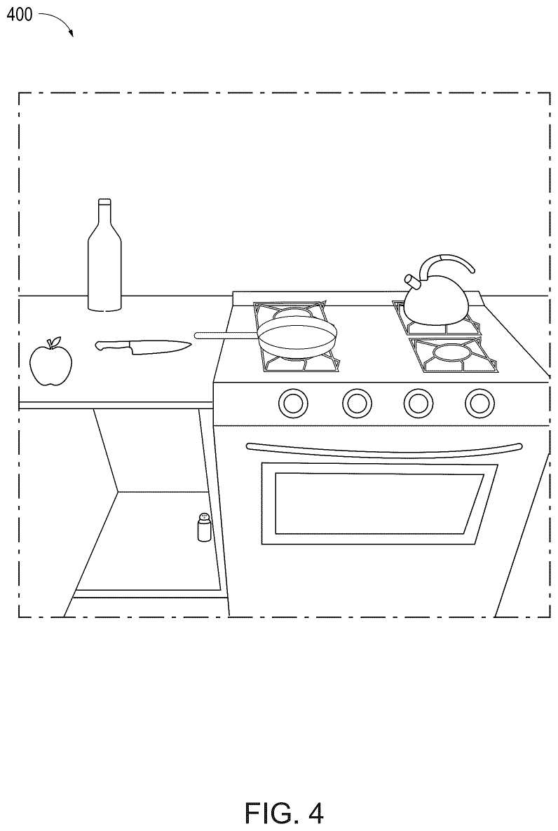

FIG. 4 is an exemplary input associated with the system for enhancing reasoning capabilities in a VLM with GFlowNets of FIG. 1, according to one aspect. An example of an input image 400 is illustrated in FIG. 4. You are an environment expert. Your goal is to select the best next action from the Admissible Next Actions based on the current state and image to complete the task. Use “[DONE]” when you think you have completed the task. According to one aspect, the task may be: “Your task is to put a cool mug in cabinet”. The Current State may be: “[‘You arrive at loc 1. The cabinet 1 is open. On the cabinet 1, you see a pan 1, a kettle 1, a winebottle 1, a apple 1, a stoveknob 1, a stoveknob 2, a stoveknob 3, a stoveknob 4, a knife 1, a saltshaker 1, and a bread 1.’]”. Admissible Next Actions may include: [‘go to countertop 1’, ‘go to cabinet 2’, ‘go to countertop 2’, ‘go to stoveburner 1’, ‘go to drawer 1’, ‘go to drawer 2’, ‘go to drawer 3’, ‘go to stoveburner 2’, ‘go to stoveburner 3’, ‘go to stoveburner 4’, ‘go to drawer 4’, ‘go to cabinet 3’, ‘go to cabinet 4’, ‘go to microwave 1’, ‘go to cabinet 5’, ‘go to cabinet 6’, ‘go to cabinet 7’, ‘go to sink 1’, ‘go to sinkbasin 1’, ‘go to fridge 1’, ‘go to toaster 1’, ‘go to coffeemachine 1’, ‘go to cabinet 8’, ‘go to drawer 5’, ‘go to drawer 6’, ‘go to drawer 7’, ‘go to drawer 8’, ‘go to shelf 1’, ‘go to shelf 2’, ‘go to countertop 3’, ‘go to shelf 3’, ‘go to drawer 9’, ‘go to garbagecan 1’, ‘open cabinet 1’, ‘close cabinet 1’, ‘take pan 1 from cabinet 1’, ‘take kettle 1 from cabinet 1’, ‘take winebottle 1 from cabinet 1’, ‘take apple 1 from cabinet 1’, ‘take stoveknob 1 from cabinet 1’, ‘take stoveknob 2 from cabinet 1’, ‘take stoveknob 3 from cabinet 1’, ‘take stoveknob 4 from cabinet 1’, ‘take knife 1 from cabinet 1’, ‘take saltshaker 1 from cabinet 1’, ‘take bread 1 from cabinet 1’, ‘inventory’, ‘look’, ‘examine cabinet 1’].

According to one aspect, the response should be a valid JSON file in the following format:

{
“thoughts”: ”first describe what do you see in the image using the text
description, then carefully think about which action to complete the task.”,
“action”: “an admissible action” or “[DONE]”
}

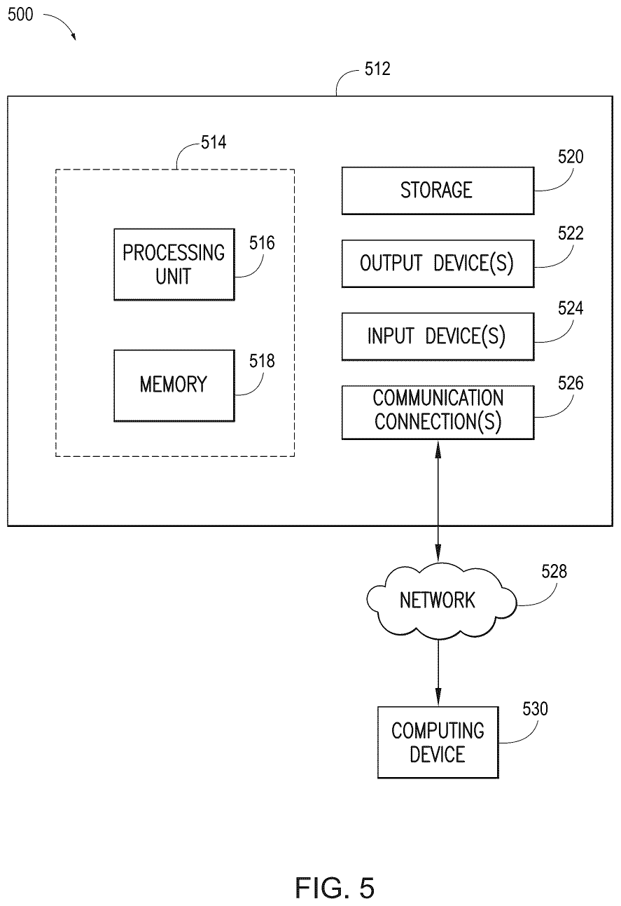

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two.

This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

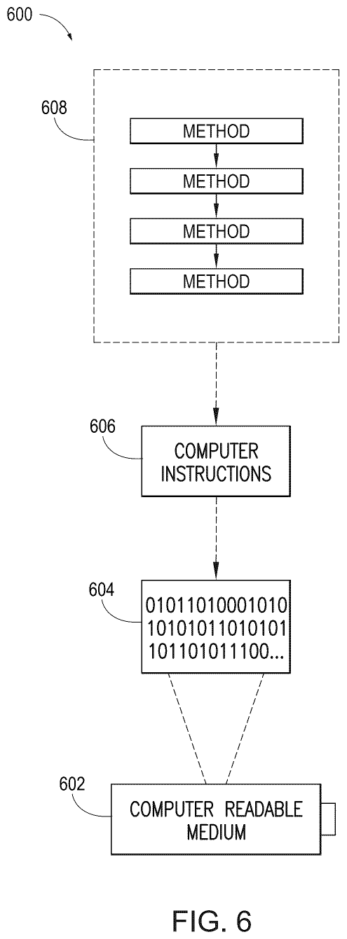

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 200 for enhancing reasoning capabilities in a vision language model (VLM) with Gflownet of FIG. 2. In another aspect, the processor-executable computer instructions 606 may be configured to implement a system, such as the system 100 for enhancing reasoning capabilities in a VLM with Gflownet of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for enhancing reasoning capabilities in a vision language model (VLM) with generative flow networks (GFlowNets), comprising:
a memory storing one or more instructions; and
a processor executing one or more of the instructions stored on the memory to perform:
generating a chain of thought (CoT) reasoning and an action for a first time-step based on a vision language model (VLM), an input observation image, and an input text prompt;
generating an action space for a second time-step and a sequence of transitions based on a simulation environment, the CoT, and the action for the first time-step; and
fine-tuning the VLM based on updating a forward policy of a generative flow network (Gflownet) based on buffering the sequence of transitions and one or more losses.

2. The system for enhancing reasoning capabilities in the VLM with GFlowNets of claim 1, comprising a sensor sensing the input observation image.

3. The system for enhancing reasoning capabilities in the VLM with GFlowNets of claim 1, wherein the input text prompt includes a goal description, a history of states, a history of actions, and the action space.

4. The system for enhancing reasoning capabilities in the VLM with GFlowNets of claim 1, wherein the VLM includes an encoder and a projector generating a vision encoding for the VLM based on the input observation image.

5. The system for enhancing reasoning capabilities in the VLM with GFlowNets of claim 1, wherein the VLM includes a text tokenizer generating a text token for the VLM based on the input text prompt.

6. The system for enhancing reasoning capabilities in the VLM with GFlowNets of claim 1, wherein the simulation environment executes the action to generate a reward, an observation at the second time-step, and the action space for the second time-step.

7. The system for enhancing reasoning capabilities in the VLM with GFlowNets of claim 1, wherein the processor generates a text prompt for the second time-step based on a function, a history of states, a history of actions, the action space for a second time-step, and an observation at the second time-step.

8. The system for enhancing reasoning capabilities in the VLM with GFlowNets of claim 1, wherein one or more of the losses is a Variance Trajectory-Balanced (TB) loss that ensures a probability of generating a complete trajectory is proportional to a reward.

9. The system for enhancing reasoning capabilities in the VLM with GFlowNets of claim 1, wherein one or more of the losses is a Subtrajectory-Balanced (SubTB) loss that ensures a segment of a CoT reasoning path remains consistent.

10. The system for enhancing reasoning capabilities in the VLM with GFlowNets of claim 1, wherein one or more of the losses is a Detailed Balanced (DB) loss that ensures that a transition between a first state and a second state is balanced by matching a forward flow and a backward flow at each step of a trajectory.

11. A computer-implemented method for enhancing reasoning capabilities in a vision language model (VLM) with generative flow networks (GFlowNets), comprising:
generating a chain of thought (CoT) reasoning and an action for a first time-step based on a vision language model (VLM), an input observation image, and an input text prompt;
generating an action space for a second time-step and a sequence of transitions based on a simulation environment, the CoT, and the action for the first time-step; and
fine-tuning the VLM based on updating a forward policy of a generative flow network (Gflownet) based on buffering the sequence of transitions and one or more losses.

12. The computer-implemented method for enhancing reasoning capabilities in the VLM with GFlowNets of claim 11, wherein the input text prompt includes a goal description, a history of states, a history of actions, and the action space.

13. The computer-implemented method for enhancing reasoning capabilities in the VLM with GFlowNets of claim 11, wherein one or more of the losses is a Variance Trajectory-Balanced (TB) loss that ensures a probability of generating a complete trajectory is proportional to a reward.

14. The computer-implemented method for enhancing reasoning capabilities in the VLM with GFlowNets of claim 11, wherein one or more of the losses is a Subtrajectory-Balanced (SubTB) loss that ensures a segment of a CoT reasoning path remains consistent.

15. The computer-implemented method for enhancing reasoning capabilities in the VLM with GFlowNets of claim 11, wherein one or more of the losses is a Detailed Balanced (DB) loss that ensures that a transition between a first state and a second state is balanced by matching a forward flow and a backward flow at each step of a trajectory.

16. A system for enhancing reasoning capabilities in a vision language model (VLM) with generative flow networks (GFlowNets), comprising:
a memory storing one or more instructions; and
a processor executing one or more of the instructions stored on the memory to perform:
generating a chain of thought (CoT) reasoning and an action for a first time-step based on a vision language model (VLM), an input observation image, and an input text prompt; and
generating an action space for a second time-step and a sequence of transitions based on a simulation environment, the CoT, and the action for the first time-step,
wherein the VLM is fine-tuned during a training stage based on updating a forward policy of a generative flow network (Gflownet) based on buffering the sequence of transitions from the training stage and one or more losses.

17. The system for enhancing reasoning capabilities in the VLM with GFlowNets of claim 16, wherein the input text prompt includes a goal description, a history of states, a history of actions, and the action space.

18. The system for enhancing reasoning capabilities in the VLM with GFlowNets of claim 16, wherein one or more of the losses is a Variance Trajectory-Balanced (TB) loss that ensures a probability of generating a complete trajectory is proportional to a reward.

19. The system for enhancing reasoning capabilities in the VLM with GFlowNets of claim 16, wherein one or more of the losses is a Subtrajectory-Balanced (SubTB) loss that ensures a segment of a CoT reasoning path remains consistent.

20. The system for enhancing reasoning capabilities in the VLM with GFlowNets of claim 16, wherein one or more of the losses is a Detailed Balanced (DB) loss that ensures that a transition between a first state and a second state is balanced by matching a forward flow and a backward flow at each step of a trajectory.
